(19) United States
(12) Patent Application Publication
(10) Pub. No.: US 2008/0312815 A1
(43) Pub. Date: Dec. 18, 2008

(54) INTERACTIVE TOUCH SCREEN LOCATOR AND GUIDE

(76) Inventor: Randy M. Stoler, San Anselmo, CA (US)

Correspondence Address: FLIESLER MEYER LLP, 650 CALIFORNIA STREET, 14TH FLOOR, SAN FRANCISCO, CA, 94108, US

(21) Appl. No.: 12/051,653

(22) Filed: Mar. 19, 2008

Related U.S. Application Data
(63) Continuation of application No. 10/712,556, filed on Nov. 12, 2003, now abandoned.
(60) Provisional application No. 60/426,218, filed on Nov. 14, 2002.

(51) Int. Cl. G01C 21/00

(52) U.S. Cl. 701/200

(57) ABSTRACT

An interactive system that allows a user to input a list of desired products and receive guidance regarding the location of the desired products within a store. In one embodiment, the system can provide the user with time or distance efficient navigation instructions and/or can provide the user with suggested and/or alternate products.

### CLAIM OF PRIORITY

This application is a continuation of U.S. patent application Ser. No. 10/712,556 filed Nov. 12, 2003 entitled INTERACTIVE TOUCH SCREEN GUIDE by Randy M. Stoler, currently pending, and claims priority to provisional application No. 60/426,218 filed Nov. 14, 2002, entitled INTERACTIVE TOUCH SCREEN GUIDE by Randy M. Stoler, the complete contents of which are incorporated herein by reference.

### BACKGROUND

1. Field of the Invention

The present invention relates generally to a method and apparatus to locate items and guide consumers through a facility in a time and/or distance economic manner.

2. Description of Related Art

As retail and wholesale establishments become larger and larger, it has become increasingly difficult for the casual consumer to locate items within these stores. Additionally, given the enormous size and variety of products carried by some of the “superstores,” it can be difficult, if not impossible, to locate an employee within the store who can direct consumers to the correct locations within the “superstore” to find the particular item or items that the consumer is interested in purchasing. Oftentimes, consumers are sent from one corner of the store to another as employees attempt to direct the consumers to their desired products. As a result of the inability to locate items expeditiously, consumers are often frustrated and simply leave the store without locating the products they came in seeking.

Street routing and interactive mapping systems for guiding people through streets from one point to another have been commercially available for several years. Additionally, way point routing with Global Positioning System (GPS) assistance has recently been successfully employed in automobiles to aid drivers in navigation. However, retail and wholesale establishments still rely on antiquated static maps to provide consumers with general guidance within their stores.

What is needed is an interactive guidance system that will allow a user to efficiently locate items in a store and navigate through a store to retrieve items that the consumer is seeking.

### BRIEF DESCRIPTION OF THE DRAWINGS

FIG. 1 is a list which details items that a consumer is seeking to purchase from a store.

FIG. 2 is a block diagram of one embodiment of the interactive guidance system.

FIG. 3 is an example of a guidance map that can be generated by the system shown in FIG. 2.

FIG. 4 is an example of an item list and suggestion list that can be generated by the system shown in FIG. 2.

FIG. 5 is one embodiment of an interactive inventory location management system that can be used in connection with the system shown in FIG. 2.

FIG. 6 is an alternate view of the interactive inventory location management system shown in FIG. 5.

FIG. 7 is a diagram of the steps performed in FIGS. 1-6.

### DETAILED DESCRIPTION

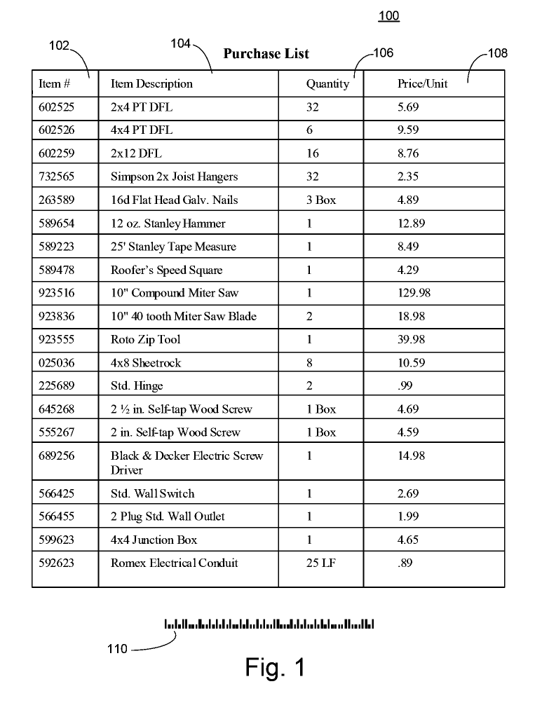

FIG. 1 shows one embodiment of a purchase list 100 that a consumer can create prior to entering a store. In the embodiment shown in FIG. 1, the list includes an item number 102, an item description 104, a quantity 106 and a price/unit 108 for each item on the list. However, in alternate embodiments various other information can be included and/or the list can contain only an item description or an item number.

In the embodiment shown in FIG. 1, the list can be developed in real time on a computer connected to the store's web page over the Internet or via some other connection mechanism. In this manner, the consumer can check pricing and availability of products and/or obtain additional information regarding the products that they are interested in. Once the consumer has completed their shopping list, they can print out a purchase list (FIG. 1), download the purchase list to a handheld computing device, save the purchase list to a computer readable media, or store the purchase list on the store's system for later retrieval.

In the embodiment shown in FIG. 1, the purchase list is a computer printout. The printout includes a identifying code 110 at the bottom of the printout that identifies the contents of the purchase list in any known manner. The identifying code can be any sequence of numbers, letters, characters or symbols and/or any other identifiable mark.

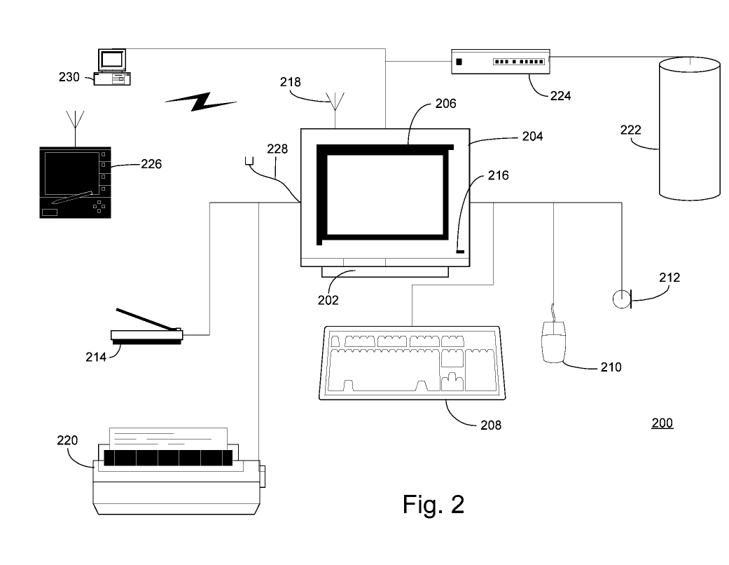

FIG. 2 depicts one embodiment of a system 200 which a customer can interact with in a store. The system 200 includes a computer 202 that is connected with a display 204. The computer 202 is coupled with numerous input devices including a touch screen overlay 206, a keyboard 208, a pointing device 210, a microphone 212, a scanning device 214, an infrared port (transmitter/receiver) 216, and a wireless transmission/reception antenna 218. In the embodiment shown in FIG. 2, the computer 202 is also connected to a printer 220 and an external database 222 via a bridge 224. Although FIG. 2 depicts the system 200 containing specific components, in alternate embodiments the system 200 can include various known input and output devices and components.

In the embodiment shown in FIG. 2, the computer 202 is connected to a bridge 224 that is connected to a database 222. The database 222 can be the store's inventory database which contains information regarding pricing and availability, and may also store information regarding item location. However, in alternate embodiments, location and inventory information may be stored in multiple databases which the computer 202 can access. Additionally, in the embodiment shown in FIG. 2, the computer 202 is connected to an external computer system 230 such that the external computer system can update and control the functions and operation of the computer 202 or update any databases contained on the computer 202.

In still further alternate embodiments, the computer 202 may not be constantly connected with the database 222. The computer 202 may periodically download information from the database 222 or databases and store the information locally.

In the embodiment shown in FIG. 2, a consumer can enter data relating to items that they are interested in locating or purchasing. In the embodiment shown, the consumer can enter the data either via the keyboard 208, through interaction with the touch screen 206 or the mouse 210, through the microphone and voice recognition software or hardware, through the scanning device 214, or wirelessly via the infrared port 216 or the antenna 218 or any other convenient mechanism.

If the consumer enters data via either the keyboard 208, mouse 210, microphone 212 or touchscreen 206 or any other input mechanism, the computer 202 can access the database 222 and determine pricing, location and availability of the requested products and provide the consumer with immediate interactive feedback regarding each item entered. Additionally, if the consumer has generated a purchase list 100, the consumer can scan the identifying code 110 of the purchase list 100 and the system 200 will retrieve information related to items on the purchase list 100 and provide the consumer with feedback regarding pricing, location and availability. Alternately, a consumer may store a purchase list 100 on a mobile computing device 226. The consumer may then transmit the purchase list 100 to the system 200 either wirelessly via the infrared port 216 or antenna 218 or via a detachable electronic tether 228.

After the computer 202 has received location and availability information for items on the purchase list 100, the computer 202 can then determine the most efficient route through the store for the consumer to take in order to gather the desired items. Additionally, the user can be provided with suggested additional or alternate items, notified of special offers, sale or coupon items and/or provided with information related to the specific items on the purchase list 100. The consumer is then provided with a routing guide which can be in the form of a map or detailed directions. In the embodiment shown in FIG. 2, the consumer can be furnished with the routing guide in the form of a computer printout or an electronic transmission to the consumer's mobile computing device 226.

In the embodiment shown in FIG. 2, the computer 202 is also connected with an external computing source 230. The external computing source is capable of interacting with and controlling the computer 202 and the components associated with the computer 202. In this manner, the external computer source can be used to upgrade, install or delete software on the computer 202, diagnose and fix problems with the computer 202 or any of its associated components, or obtain information regarding the computer and its associated components or obtain information regarding sales volumes, number and types of coupons dispensed, system usage and other similar information.

In addition to providing location and routing information regarding items in the store, the system can also provide the customer with coupons related to items in the store, present the consumer with current special offers, present the customer with an opportunity to apply for a store credit card, or provide the consumer with video or printed instructions related to a topic of interest to the consumer.

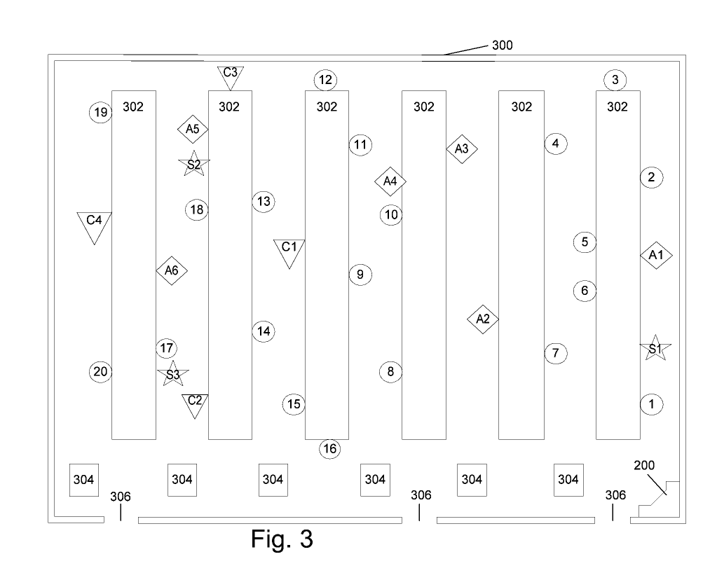

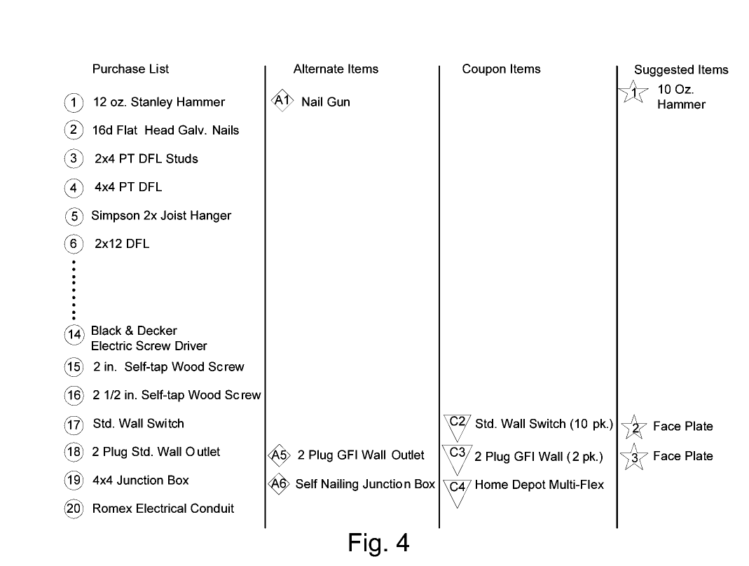

FIGS. 3 and 4 depict a computer printout of a map 300 and an associated itemized list 400 that can be generated by the system 200 shown in FIG. 2. The map 300 shows the general layout of the store including the location of the system 200, the aisles 302, checkout stations 304, and the location of ingress and egress points 306. Items 1 through 20 which are contained in circles indicate the locations of the various items that are indicated on the purchase list 100 and entered into the system 200. In the embodiment shown in FIG. 1, the items on the purchase list have been re-sequenced such that by proceeding from number 1 to 20 sequentially, the consumer would take the shortest path through the store to obtain the items on the purchase list 100. In this way, the consumer is provided with not only the location of all the items they are seeking, but also the shortest path through the store to obtain the items.

FIGS. 3 and 4 also include items A1 through A6 contained in diamonds, items C1 through C3 contained in triangles and items S1 through S3 contained in stars. Items A1 through A6 are suggested alternate items which the consumer may be interested in purchasing in place of the item indicated on the purchase list 100. By way of example, item 1 on the purchase list is a 12 oz. Stanley Hammer. The system may suggest the purchase of a Porter Cable nail gun instead of or in addition to the hammer. Such alternate suggestions could be based on the individual products being purchased, the overall contents of the purchase list 100, special products that the store wishes to promote or any other data or combination of data.

Items C1 through C3 represent items that are on special offer or have a coupon rebate associated therewith. The selection of special offer or coupon rebate items which is presented to the consumer can be randomly generated or can be specifically selected based on any set of predetermined criteria. By way of example, item C3 is a two-pack of Ground Fault Interrupted wall plugs which are offered at a price less than if two units were purchased individually. In this example, item C3 is specifically related to item 18 from the purchase list 100, a two-plug standard wall outlet. Thus, the consumer can directly compare and contrast the coupon item with the item from the purchase list. While such one-to-one correlation with the purchase list is convenient, it is not necessary. As noted above, coupon rebate or special offer items may be presented randomly, in accordance with the store's instructions or based on a fee paid by the manufacturer or distributor of the item.

Items S1 through S3 represent items that are suggested complementary items. By way of example, item S2 is a face plate which is associated with item number 18 on the purchase list 100, a standard wall switch. The system can be programmed to review the purchase list and determine if common complementary items are missing from the list. The system can then provide the consumer with a list of suggested complementary items and their locations within the store. Supplemental routing through the store can then be determined such that the consumer can retrieve the desired items in an efficient manner.

In the embodiment shown in FIG. 3, the consumer can interact with the map presented to the consumer on the monitor 204 and add supplemental items, coupon rebate or special offer items and/or alternate items to heir purchase list 100. Alternately, the consumer may elect not to make any additions or alterations to their original purchase list 100. Once the purchase list is finalized, the computer can recalculate the most efficient path through the store, using known algorithms, based on the finalized purchase list 100. The consumer may then retrieve a finalized purchase list with proposed alternate items, coupon rebate or special offer items and suggested items listed in addition to the original purchase list items, together with a map indicating the locations of each of the items and a proposed route through the store.

The proposed route through the store need not be based on the shortest path through the store, but can be designed to direct customers past a given area within the store through which the store would like additional consumer traffic, or can be designed to take the consumer past a particular product. The store and/or manufacturer or distributor of such products can pay either the store or the owner/operator of the system 200 to have their products included on the coupon rebate or special offer list or to have consumers directed past their products in the routing provided.

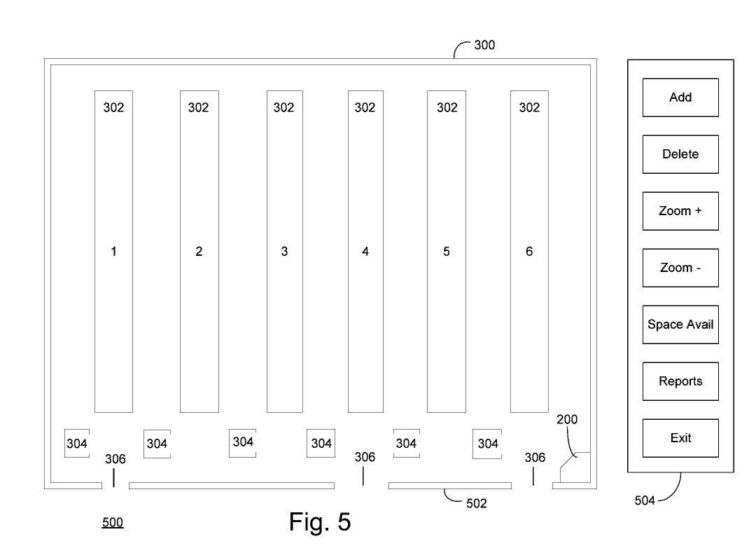

FIG. 5 is a screen capture of an interactive inventory location management system 500. FIG. 5 shows a map of the store 502 and a tool bar 504. The tool bar 504 includes interactive buttons to Add 506 items to the store inventory, delete 508 items from the store inventory, Zoom+510 in on the various portions of the map, Zoom−512 out to see more of the store map, show space available 514 within the store for new or additional products, generate various reports 516 related to available space, stock on-hand, sales volumes or any other desired report related to items and location of the items within the store and an exit 518 button to terminate this portion of the interactive program. Using the program, an authorized person can manage the locations of various items throughout the store. In one embodiment, the map can be interactive such that pointing to a location in the store can give immediate “pop-up” information regarding the inventory located in that area, or selecting a location on the map can zoom in on the location and provide detailed information regarding the items stored in the selected location.

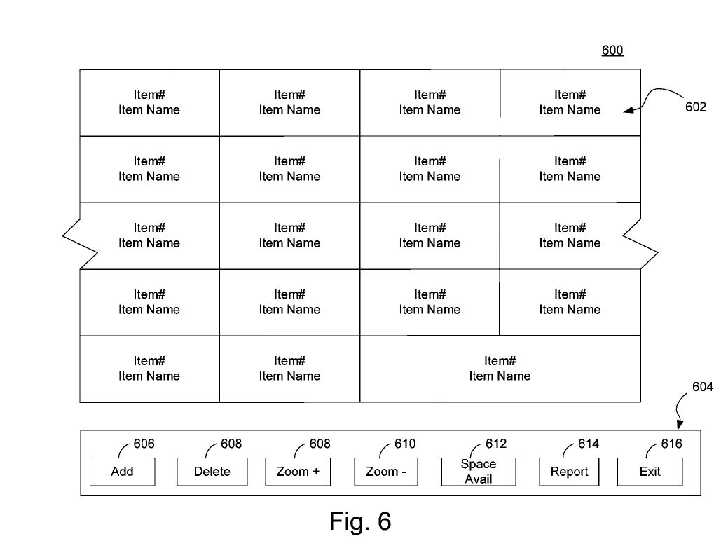

FIG. 6 is a screen capture of an embodiment of the interactive inventory location management system shown in FIG. 5. The interactive system may be accessed directly from the computer 202 or may be accessed remotely either via a wired or wireless connection to the system 200. FIG. 6 shows a detailed view of one segment 600 of a selected aisle within the store. The detailed view may be accessed via the zoom-in function of an interactive map, such as that shown in FIG. 5 or may be directly accessed based on grid system or accessed using any other convenient method that allows a user to select a section within the store.

FIG. 6 depicts numerous portions 602 of one segment 600 of a selected aisle in the store. In the embodiment shown in FIG. 6, each segment can include an item number and an item description. In alternate embodiments, any convenient information can be included in each portion, such as a Universal Product Code, an in-store identification code, a department code, a detailed description or a list of uses or any other similar piece of information.

The embodiment shown in FIG. 6 also includes a tool bar 604 that has interactive buttons to Add 606 items to the store inventory, delete 608 items from the store inventory, Zoom+610 in on the various portions of the segment 600, Zoom−612 out to see more of the segment 600, show space available 614 within the segment for new or additional products, generate various reports 616 related to available space, stock on-hand, sales volumes or any other desired report related to items and location of the items within the segment 600 and an exit 618 button to terminate this portion of the interactive program. Using the program, an authorized person can manage the locations of various items throughout the store or segment 600. In one embodiment, the segment 600 can be interactive such that pointing to a location in the segment can give immediate “pop-up” information regarding the inventory located in that portion 602, or selecting a location in the segment can zoom in on the area and provide detailed information regarding the items stored in the selected area.

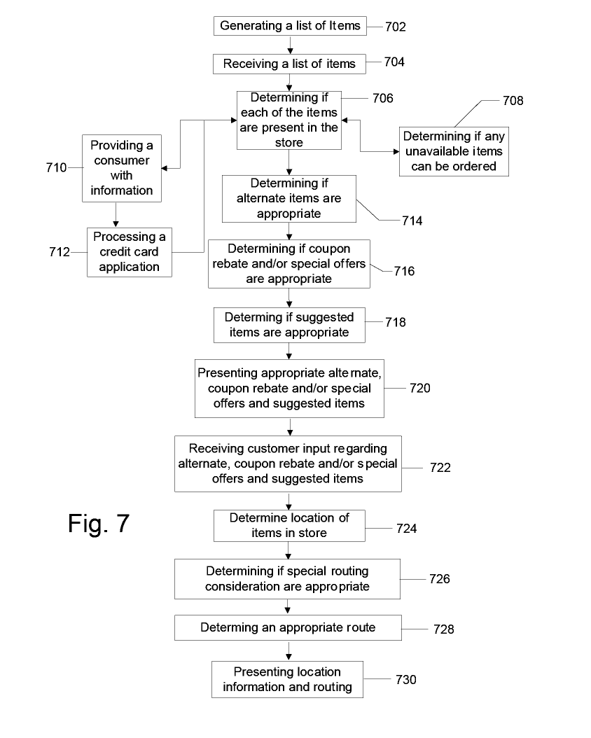

FIG. 7 depicts the steps to perform the method described in FIGS. 1 through 6. Step 702 is generating a list of items. As described above, the list can be generated online, interactively at the system interface using any convenient input device or on a mobile computing device. Step 704 is receiving the list of items. As described above, this can be accomplished in any convenient manner. By way of example, the consumer can enter the list manually via any convenient input mechanism, can scan an identifying code associated with the generated list or can download the list or identifying indicator via wireless or wired connection with a mobile computing device.

Step 706 is the step of determining if items are available in the store. This step can be performed in any known and/or convenient manner, such as interactive access with the store's inventory database, accessing a local database that is periodically updated from the store's inventory database, or any in other convenient manner.

Step 708 is the step of determining if items that are not available in the store can be ordered. This step can be performed in any known and/or convenient manner, such as interactive access with a store's or external inventory of available-for-order-products database, accessing a local database that is periodically updated, accessing a global order database which contains a list of items available for order, or in any other convenient manner.

Step 710 is the step of providing the consumer with information. This step can include providing detailed information regarding particular items entered by the user, providing overview information regarding items that may be of interest to the consumer, providing the consumer with information regarding a store or store-associated credit card, providing the consumer with miscellaneous or specific “How to” information, information pertaining to drug interactions, providing the consumer with general information about the store and/or providing the consumer with any information that the store may deem appropriate. Although step 710 is shown as being performed while the inventory checking steps 706, 708 are being performed, step 710 can be performed before or after the inventory checking steps 706, 708. In one embodiment, the “How to” instructions and/or other data may be delivered to the consumer together with a list of items and locations for the items and/or “How to” instructions and or data may be delivered to the consumer without the generated list and locations. Although shown in the embodiment depicted in FIG. 7, the step of providing customer with information is not necessary and in alternate embodiment, may not be included.

Step 712 is the step of receiving information to process a credit card application. This step may be performed in any convenient and/or known manner. The step involves interaction with the consumer to obtain credit information sufficient for a credit granting agency to make a credit decision regarding the consumer. The credit application process may be an instant approval type transaction or may simply be a data collection type service that allows later processing of the consumer's credit application. Although this step is depicted as emanating from the step of providing the consumer with information, in alternate embodiments the credit card application can be accessed at any point in time during the consumer's interaction with the system. In alternate embodiments, this step may not be included.

Step 714 is the step of determining if alternate items are appropriate to present to the consumer. This step can be performed in any convenient and/or known manner. As described above, the determination can be made based on individual items that a consumer has selected, a grouping of items that a consumer has selected or any other information or data that the store deems appropriate. Additionally, in alternate embodiments, this step may not be included.

Step 716 is the step of determining which, if any, coupon rebate and/or special offer items are appropriate for presentation to the consumer. This step can be performed in any convenient and/or known manner. As described above, the determination can be made based on individual items that a consumer has selected, a grouping of items that a consumer has selected or any other information or data that the store deems appropriate. Additionally, in alternate embodiments this step may not be included.

Step 718 is the step of determining what, if any, suggested items are appropriate to be presented to the consumer. This step can be performed in any convenient and/or known manner. As described above, the determination can be made based on individual items that a consumer has selected, a grouping of items that a consumer has selected or any other information or data that the store deems appropriate. Additionally, in alternate embodiments this step may not be included.

Step 720 is the step of presenting the consumer with appropriate alternate items, coupon rebate and/or special offer items, and/or suggested items. This may be performed in any convenient manner which may include presenting the customer with a final printed or electronic map of the store with the alternate items, coupon rebate and/or special offer items and/or suggested items indicated on the map (see FIGS. 3 and 4). In the embodiment shown in FIG. 7, the user can be presented with the option to add any of the alternate items, coupon rebate and/or special offer items, and/or suggested items to the consumer's purchase list. Additionally, in alternate embodiments this step may be eliminated.

Step 722 is the step of receiving a consumer input regarding alternate items, coupon rebate and/or special offer items, and/or suggested items. Input regarding whether the consumer wishes to have the items included on the purchase list can be received in any known and/or convenient manner. In alternate embodiments, this step may be eliminated.

Step 724 is the step of determining the location of each item on the consumer's purchase list. This step can be preformed in any convenient and/or known manner. In one embodiment, the system can access a local database containing the locations of each item within the store. In an alternate embodiment, the system can access an external database containing information regarding locations of items within the store. In a still further alternate embodiment, the data may be stored in and accessed from any convenient location.

Step 726 is the step of determining if any specific routing is appropriate. This step can include accessing a database, local or otherwise, that includes a database of points in the store which consumers should be directed past. Such points in the store may be specific displays within the store or specific manufacturer's items or simply general areas within the store. Such information can then be incorporated into the proposed routing for the consumer in an effort to get the consumer to travel past one or more of the points as they journey through the store. In alternate embodiments, these points may be randomly generated or they may be specifically restricted to select locations or select items. In still further alternate embodiments, the step may not be included.

Step 728 is the step of determining routing within the store. This step can be performed in any known and/or convenient manner. The routing step can take into account alternate items, coupon rebate and/or special offer items, suggested items, items on the purchase list and/or special routing considerations from step 726. Routing can be based on any factor—shortest distance and/or fastest route or the like. Additionally, in alternate embodiments, this step may not be included and the consumer may simply be provided with the listing of items and their respective locations within the store.

Step 730 is the step of presenting the consumer with location and/or navigation information. The information can be provided to the consumer in any convenient and/or known manner. In one embodiment, the user may receive a printout of a store map with the items of interest indicated by numbers of symbols (see FIG. 3). In an alternate embodiment, the consumer may receive the information electronically to a mobile computing device. In still further alternate embodiments, the information may simply be presented on a display for the user to read.

Further alternate embodiments include combining the above-described system with an Automated Teller Machine (ATM) or any other electronic machine located within a store. Additionally, the system may be incorporated with an interactive event ticketing system.

While the system has been described with reference to specific embodiments, this description is not intended to be construed in a limiting sense. Various modification of the disclosed embodiments, as well as other embodiments of the invention, will be apparent to persons skilled in the art upon reference to this description. It is therefore contemplated that the appended claims will cover any such modification or embodiments as fall within the true scope of the system described herein.

What is claimed is:

1. A location system comprising:
an input mechanism for receiving data;
a computer adapted to receive said data from said input mechanism;
a database containing location information for items within a store; and
an output device operatively associated with said computer processor adapted to provide a user with location information in response to said data.

2. The location system of claim 1 further comprising a system for determining an efficient routing path through said store.

3. The location system of claim 1 wherein said system device is capable of providing a user with information related to charge card application material.

4. The location system of claim 3 wherein said system is capable of collecting user information related to a charge card application.

5. The location system of claim 1 wherein said system can provide a user with at least one of electronic coupons and printed coupons.

6. The location system of claim 1 wherein said system further comprises an event ticketing system.

7. The location system of claim 1 wherein said system further comprises a printer capable of generating a map of said store with indications of item locations.

8. The location system of claim 5 wherein said location information includes location information for items related to said coupons.

9. The location system of claim 1 wherein said database is located within the computer.

10. The location system of claim 9 wherein said database can be updated from an external source.

11. The location system of claim 1 wherein said database is located external to said computer.

12. A method for directing persons to items of interest within a store comprising the steps of:
receiving a list of items;
determining the location of said items within the store;
outputting location information for each item.

13. The method of claim 12 further comprising the step of:
presenting a user with items not included on said list.

14. The method of claim 13 wherein said step of presenting includes the step of providing the user with at least one of electronic and tangible coupons.

15. The method of claim 12 further comprising the steps of:
determining a distance efficient path through the store; and
presenting said distance efficient path.

16. The method of claim 12 further comprising the steps of:
presenting a user with information related to at least one of items contained on said list and items not contained on said list.

17. The method of claim 16 wherein said information is related to potential safety hazards.

18. The method of claim 12 further comprising the step of:
presenting a user with information pertaining to products unrelated to items available within the store.

19. The method of claim 12 further comprising the step of:
presenting a user with information pertaining to services.

20. The method of claim 12 further comprising the step of:
presenting a user with information that the store deems appropriate.

21. The method of claim 12 further comprising the step of:
receiving information from a remote source.
